(19) United States
(12) Patent Application Publication
(10) Pub. No.: US 2003/0019747 A1
(43) Pub. Date: Jan. 30, 2003

(54) Manufacturing method with integrated test and validation procedures

(76) Inventors: John Saffell, Hampshire (GB); Richard Smith, Essex (GB); Paul John Denning, Scariff (IE)

Correspondence Address: MAYER, FORTKORT & WILLIAMS, PC, 251 NORTH AVENUE WEST, 2ND FLOOR, WESTFIELD, NJ, 07090, US

(21) Appl. No.: 09/909,131

(22) Filed: Jul. 19, 2001

(51) Int. Cl. G01N 27/26; G01N 27/404

(52) U.S. Cl. 204/400; 204/415

(57) ABSTRACT

A manufacturing method and sensors produced by that manufacturing method including an integrated assembly test and validation procedure benefiting from a central control. The use of the same gas supply for each stage of the manufacturing process and for research, each sensor produced by the process is labelled and is provided with access to information pertaining to that individual sensor and/or the batch within which that sensor was made. A system validation procedure deconstruct systematic errors in different parts of a gas supply system.

### FIELD OF THE INVENTION

The present invention relates to a manufacturing method including integrated, traceable, test and validation procedures for use in the manufacture of electrochemical gas sensors The invention includes a manufacturing facility and products of the manufacturing method.

### BACKGROUND

Many types of electrochemical gas sensor are sold at the present time; for example, sensors for determining carbon monoxide, dihydrogen sulfide, sulfur dioxide, nitrogen monoxide, chlorine, nitrogen dioxide, oxygen and hydrogen These sensors have apertures for contact with a gaseous atmosphere and electrodes at which, under appropriate conditions, an electrochemical reaction takes place which is dependent on analyte concentration.

A typical example is a carbon monoxide sensor, for example CO-AF available from Alphasense Ltd of Great Dunmow, England, which has a planar working electrode formed by sintering at elevated temperature a mixture of catalyst (e.g. Platinum Black) and a suspension of PTFE, then pressing the sintered mixture onto a microporous PTFE membrane. A reference electrode is placed between the working electrode and a similarly formed counter electrode, with a wick in contact with an electrolyte reservoir, supporting a three to seven Molar sulphuric acid electrolyte.

The precision, bias, reproducibility and other operating parameters of electrochemical gas sensors are of great importance to their commercial value and so gas sensors are routinely tested after manufacturing in order to ensure they operate within defined standards. Key factors include: response rate, repeatability, reproducibility, resolution, range and sensitivity to analyte and interferent gas concentrations.

As well as testing each individual sensor, it is known to select sensors from a batch and subject these validation sensors to specific additional tests at the end of the manufacturing process. Individual and validation tests are often customised for particular applications of the sensors, so the output from a single factory may be distributed to a large number of different commercial contexts requiring different test and validation procedures. It is desirable to ensure that correct procedures are followed that errors cannot take place, and that sensors passing through a manufacturing process are fully traceable. Therefore, an aim of the present invention is to provide a process for reliably implementing different customised test and validation procedures making it as easy as possible to customise test and validation procedures whilst ensuring a high level of record keeping and traceability.

A further problem encountered during the development and subsequent manufacture of electrochemical gas sensors is that many aspects of the sensors are highly sensitive to variations in manufacturing procedure. Differences between the environment in which sensors were researched and the environment in which they are assembled, tested and validated reduce the reliability of sensors. Therefore, a further aim of the present invention is to homogenise research, assembly, test and validation procedures in an economic, traceable and highly controllable fashion.

### BRIEF DESCRIPTION OF THE INVENTION

According to a first aspect of the present invention there is provided a method of manufacturing an electrochemical gas sensor, comprising the steps of: assembling components to form a sensor assembly having a plurality of electrodes and a plurality of terminals for making an external electrical connection to said electrodes, the sensor assembly providing a measurement dependant on an analyte gas concentration when an appropriate external circuit is applied to said terminals;.

mounting said sensor assembly on an electrical circuit board having an individual electronically readable identifier, having connectors for connecting to said terminals of said sensor assembly and having a connection to a computer system;

applying an appropriate external electric circuit to said connectors to cause measurement properties of said sensor assembly to stabilise;

the electrical circuit board monitoring said stabilisation;

the computer system periodically reading and storing measurement properties of said sensor assembly during stabilisation, said stored measurement properties being attributable to said electrical circuit board identifier and therefore to a specific sensor assembly;

determining when said stabilisation process is complete;

determining whether to select the sensor assembly for batch validation and, if it is selected, carrying out at least one validation test on said sensor assembly, the validation test including the step of measuring a validation measurement property of said selected sensor assembly and storing said validation measurement property attributably to a specific sensor assembly,

Preferably, said validation measurement property is attributable to a specific sensor assembly due to said sensor assembly remaining connected to said electronic circuit board having an electrical circuit board identifier. More preferably, the method comprises the step of said electrical circuit board automatically testing a sensor assembly for a fault and, if a fault is found, communicating the existence of said fault.

Most preferably, the method for comprising the step of labelling said sensor assembly, said label providing identifier information enabling said stored properties to be attributed to said labelled sensor assembly.

According to a second aspect of the present invention there is provided a method of manufacturing an electrochemical gas sensor, comprising the steps of:

assembling components to form a sensor assembly having a plurality of electrodes and a plurality of terminals for making an external electrical connection to said electrodes, the sensor assembly providing an electrical signal dependent on an analyte gas concentration when an appropriate external circuit is applied to said terminals:

carrying out at least one test on said sensor assembly, the results of said test being stored attributably to said sensor assembly; and

labelling said sensor assembly, said label providing identifier information enabling said test results relating to said sensor assembly to be retrieved.

Preferably, the method further comprises the step of determining whether to select a sensor assembly for batch validation; wherein, if a sensor assembly is selected for batch validation, at least one validation test is carried out on said selected sensor assembly, said validation test results being stored attributably to a batch of sensors, wherein identifier information provided on a label enables validation test results relating to a batch of said sensor assemblies to be retrieved.

More preferably, said label is customised depending on the purchaser of said electrochemical gas sensor.

According to a third aspect of the present invention there is provided a method of manufacturing an electrochemical gas sensor, comprising the steps of:

assembling components to form a sensor assembly having a plurality of electrodes and a plurality of terminals for making an external electrical connection to said electrodes, the sensor assembly providing an electrical signal dependant on an analyte gas concentration when an appropriate external circuit is applied to said terminals;

caring out at least one test on said sensor assembly, said test including the steps of measuring a first analyte gas concentration dependent electrical signal in a first controlled composition gas atmosphere;

storing said first measured signal and information concerning the first controlled composition gas atmosphere, said measured signal and information being attributable to said sensor assembly;

determining whether to select said sensor assembly for a validation study from a batch of said sensor assemblies and, if said sensor is assembly is selected, carrying out at least one validation test on the selected sensor assembly;

carrying out at least one validation study on said sensor assembly, said validation study including the step of making a second measurement of said analyte gas concentration dependent electrical signal in a second controlled composition gas atmosphere; and

storing said second measured signal and information concerning the second controlled composition gas atmosphere. said measured signal and information being attributable to said sensor assembly or said batch of said sensor assemblies.

Preferably, a single gas source supplies gas for both said test and said validation study.

More preferably, a single procedure defines gas supply dug both said test and said validation study.

Most preferably, said test procedure and said validation procedures were researched using said single procedure:

Preferably, said validation study further includes the step of connecting customised apparatus to outlets from said single gas source.

Preferably also, the method further comprises the step of halting said test procedure once a sensor assembly has been selected for validation until tie results of said validation process are available.

Typically, said test procedure is only restarted if the results of said validation process are favourable.

According to a fourth aspect of the present invention there is provided a system validation method for validating a gas supply system, the method comprising the steps of:

supplying gas to a plurality of manifolds, each manifold supplying gas to a plurality of nozzles, the supply of gas being controlled by mass flow controllers;

determining a property dependent on the concentration or amount of gas supplied to each nozzle by way of a plurality of electrochemical gas sensors, each located to give a signal dependent on the concentration or amount of gas supplied to an individual nozzle;

relocating a plurality of gas sensors to give a signal dependent on the concentration of amount of gas supplied to a different nozzle; and

thereby determining the difference in systematic errors in the gas supply to individual nozzles.

Preferably, a batch of gas sensors is located so that between them, they give signals dependent on the concentration or amount of gas supplied to each nozzle in a manifold, the relocation comprising moving said batch of sensors to another manifold and thereby determining the difference in systematic errors in the gas supply to individual manifolds.

More preferably, gas is supplied to manifolds through digital flow mass controllers and the method comprises the step of calculating the systematic error due to an individual mass flow controller. A plurality of gas sensors may be mounted on an electronic circuit board and receive gas from the same nozzle, where signals from each gas sensor receiving gas from a particular nozzle are combined to improve accuracy.

According to a fifth aspect of the present invention there is provided a sensor package comprising an electrochemical gas sensor manufactured by the method of the first, second or third aspect of the present invention and information pertaining to the results of said tests carried out on said sensor. Preferably, said information is provided in the form of a computer readable media Said information may be provided in a database, the sensor being labelled with an identifier allowing the correct information to be retrieved from the database.

### BRIEF DESCRIPTION OF THE SEVERAL DRAWINGS

An example embodiment of the present invention will now be illustrated with a reference to the following figures, in which:

FIG. 1 is a schematic overview of a manufacturing facility;

FIG. 2 is a flowchart of an assembly process for a sensor assembly;

FIG. 3 is a perspective drawing of a typical electrochemical gas sensor;

FIG. 4 is a schematic diagram of a printed circuit board;

FIG. 5 is a cross-section through a gas hood for supplying gas to sensors held on a printed circuit board;

FIG. 6 is a flow chart of test and validation procedures;

FIG. 7a is a cross-section through a stabilization rack;

FIG. 7b is a cross-section through a sensor assembly test rig;

FIG. 8 is a schematic diagram of components of a validation and research facility;

FIG. 9 illustrates a gas supply manifold; and

FIG. 10 depicts an exemplar embodiment of the nozzles formed in an array according to one aspect of the present invention.

### DETAILED DESCRIPTION OF THE PREFERRED EMBODIMENT

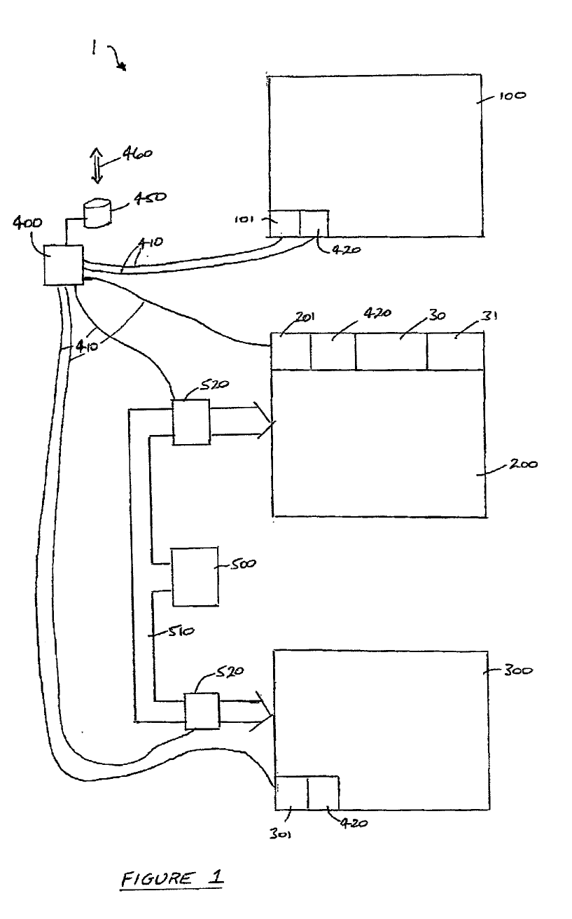

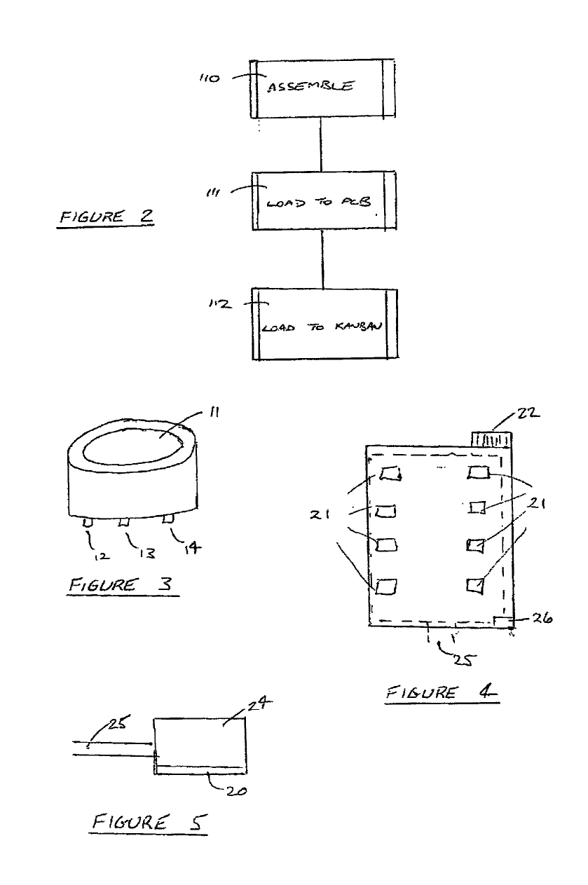

FIG. 1 is a schematic overview of key components of a manufacturing facility according to the preferred embodiment The manufacturing facility 1 comprises a sensor assembly area 100 in which key components of electrochemical gas sensors are assembled. The resulting sensor assemblies 10, illustrated in FIG. 3 are able to provide a signal responsive to analyte concentration but require further stabilization, testing and labelling before manufacturing is complete. A typical sensor assembly is prepared by selecting electrodes made of materials appropriate for the particular analyte and sucking these in a specified order, interspersed with a matrix to hold electrolyte and electrical connectors. For example, a carbon monoxide sensor, as described above, can be formed by layering platinum black(PTE suspension working, reference and counter electrodes with a wick in contact with a sulphuric acid reservoir. Electrical contacts to each electrode can be made by adding conductors in contact with each electrode as is known in the art. This procedure can be readily customised to make other types of sensor assemblies. For example, a sensor for acid gases can be made by using carbon based electrodes.

A test laboratory 200 houses apparatus and personnel required to carry out initial testing of sensor assemblies. The testing procedure typically includes a stabilization process, described below, which is, for most sensors, an essential part of the manufacturing process as it is desirable to provide pre-stabilized sensors to customers. The test laboratory 200 also cares out tests on individual sensor assemblies.

Validation and research laboratory 300 houses apparatus and personnel to car out validation of tested sensors and further research into new procedures and sensor types. A computer system 400 controls key aspects of the manufacturing process and analyses data received through sensors 101, 201, 301 in each facility, storing key information required for traceability in a centralised database 450. The computer network 410 pervades the manufacturing facility. In the preferred embodiment, the computer system 400 comprises a plurality of Windows NT ® PCs connected in a server-host network as is well-known in other applications.

A gas storage facility 500 houses supplies of gases required in test, validation and research. These include analyte gases for the sensors being manufactured Example gases are: carbon monoxide, methane, dihydrogen sulfide, carbon dioxide, sulfur dioxide., ammonia, nitrogen dioxide, hydrogen, nitrogen, nitrogen monoxide, chlorine, and oxygen. A piping network 510 accesses both test and validation laboratories and gas flow is controlled by digital mass flow controllers and valves 520 under the instruction of the computer system 400. Preferably, piping network 510 is formed from low adsorption micropolished stainless steel, A separate ventilation system (not shown) controls the atmosphere of the assembly facility 100, test facility 200 and validation facility 300. Sensors 101, 201 and 301 record atmospheric information, such as humidity, barometric pressure and temperature, on a regular basis, thereby enabling information about laboratory conditions during assembly, testing and validation of individual sensors to be later retrieved.

Computer interface peripherals 420 are provided throughout for accessing the computer system, inputting data through keyboards, mice and barcode readers and outputting information through monitors, printers, label printers and other computer peripherals. An external connection and firewall 460 allows a separate interface system to be introduced allowing customers themselves to access information in the database 450 in a controlled fashion, thereby retrieving information pertaining to the particular sensors they have purchased.

FIG. 2 illustrates procedures carried out in the assembly area 100. Firstly, a batch of sensor assemblies 10 are assembled 110 according to a predetermined manufacturing process. At this stage, sensor assemblies are not individually labelled and are kept in batches of equivalent sensors. After assembly, the sensors are loaded onto PCBs 111.

FIG. 3 illustrates a schematic diagram of a toxic gas sensor IO. Toxic gas sensor IO has an aperture for contact with a gas atmosphere 11 and a plurality of electrical contacts. In this example, there is provided a carbon monoxide sensor having working electrode connection 12, counter electrode connection 13 and reference electrode connection 14. When connected to a suitable potentiostatic circuit, as can be readily selected by one skilled in the art, the working electrode current gives a measurement of carbon monoxide concentration.

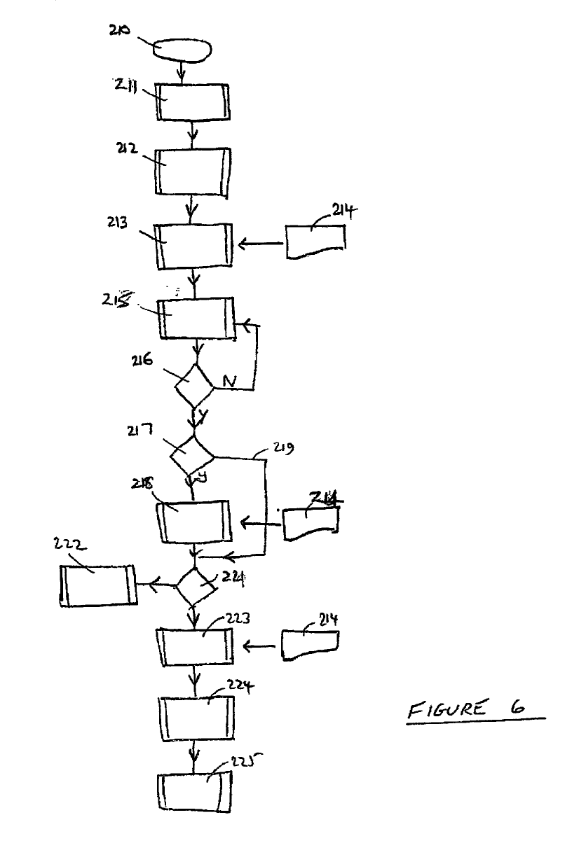

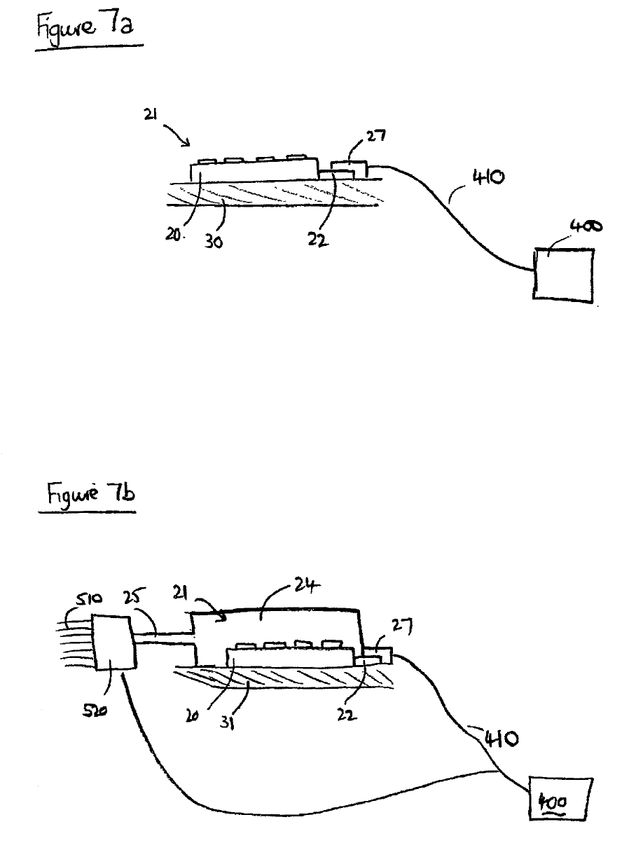

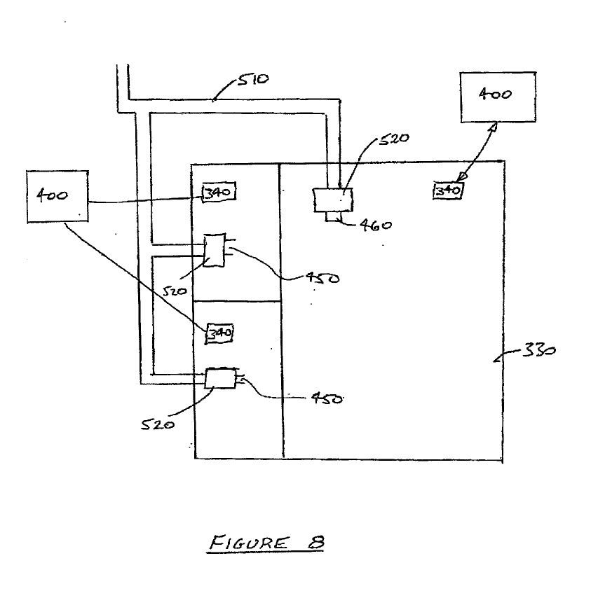

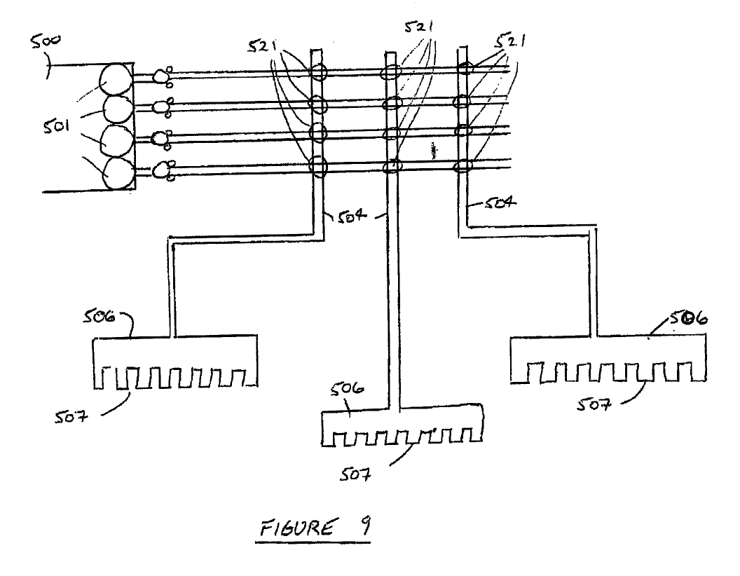

FIG. 4 illustrates a printed circuit board (PCB) 20 in schematic form. Printed Circuit board 20 has eight separate sets of electrical contacts 21 for making electrical contact with sensor electrical connections 12, 13, 14, providing support electronics such as potentiostat circuit for carbon monoxide sensors or a load resistor for oxygen sensors and a connector 22 is provided for providing power to the circuitry and communicating with a remote computer to set potentials or currents at individual electrodes and reading potentials or currents.

Preferably, the printed circuit board has a connector 23 which, when required during test and batch validation procedures, mates with a gas cover 24 shown in FIG. 5, allowing gas supplied rough connector 25 to be exposed to gas contact aperture 11 on sensor assembly 10. Each printed circuit board 20 has a unique digitally encoded identifier 26. This can be a barcode but is preferably stored in the form of read only memory and therefore, once sensor assemblies 10 are loaded onto a printed circuit board 20 in one of the available spaces 21, they can be uniquely identified during the remainder of Se test and validation process.

Preferably, a plurality of circuit boards are then loaded together into a separate batch holding rack known as a kanban. In the preferred embodiment, eight printed circuit boards are loaded, defining a kanban. Loading printed circuit boards 20 together as kanbans 112 and subsequently carrying out tests and validation procedures on entire kanbans provides increased economy of scale.

FIG. 6 is a flow chart illustrating procedures carried out in the preferred embodiment of the test facility 200. Initially, kanbans of printed circuit boards with mounted sensors 21 are brought into test facility 200. An operator enters sensor type and batch number information 211 through input peripherals 201. This allows a specific predefined test specification 214 to be selected for use in the test procedure. Computer system 400 then prompts the operator to load the kanbans of printed circuit boards 20 into a rack 30 having electrical connectors to enable a printed circuit board to be connected according to the schematic of FIG. 7a.

According to FIG. 7a, a printed circuit board 20) having a plurality of sensor assembly connecting ports 21 is connected electrically to computer system 400 through printed circuit board connector 22 mating with rack connector 27 mounted on a stabilization rack 30, thereby enabling computer system 400 to supply power to the circuit board, control the potentials and/or currents applied to individual sensor's electrodes and to receive digital electronic information of the magnitude of the signal from individual sensors 10.

Thereafter, individual sensor assemblies 10 are allowed to stabilize on stabilization rack 30. This is an important part other process of manufacturing finished gas sensors as newly made electrochemical gas sensor assemblies are typically unstable and, if used immediately, would give readings which drifted with time. During stabilization, sensor assemblies 10 are exposed to laboratory air. Preferably the air supply consists of atmospheric air filtered, humidity controlled and chemically filtered to climinate trace contaminants

At this stage, tests may be carried out on stabilization rack 30 exposed to the test facility atmosphere or on a separate test rig 31 illustrated in FIG. 7b for gas concentration dependent tests, In a preferred embodiment, a continuous test of a sensor assembly's response to ambient air is carried out on stabilization rack 30. With the exception of oxygen sensor assemblies, the analyte gas is present in negligible concentrations at room temperature, humidity and barometric Pressure, During this time, sensor assemblies 21 are maintained under appropriate electrical conditions. For a carbon monoxide sensor this would be under conditions of zero bias, that is to say that the potential between the working and reference electrodes would be maintained at zero volts. Sensor assemblies are monitored periodically by the central computer system 400 to establish the remain current output from the sensor assembly working electrode and sensors remain in stabilization until the rate of change of the mean working electrode zero current has dropped below a set value.

The stabilization time typically varies between two and forty days. Current reading at zero gas exposure is monitored every two minutes by circuitry built into each printed circuit board 23. The printed circuit board 23 is adapted to chock itself for faulty sensors by observing, for example, short circuits or unusual electrical responses and preferably has an indicator, such as one or more light emitting diodes for indicating a fault. A current reading is recorded by computer system 400 at intervals, typically between five and four hundred and eighty minutes. Therefore, a profile of a sensors zero reading is monitored through time and this information is stored in the database 450 where it can be associated with the individual sensor assembly 10. Sensor stabilization is compared with pre-set standards stored in specification 214 and sensors which do not fall within that standard are flagged to an operator.

Optionally, computer system 400 schedules sensor assembles 10 for additional testing during stabilization, with reference to sensor specific specification 214 When instructed, a kanban of sensor assemblies 214 is transferred to a testing rig 31 having electrical connections to each electrode connector 12, 13,14. At this stage, a gas housing 24 is positioned over the sensors 21 and gas is supplied to the sensor assemblies from gas storage facility 500 trough piping network 510. Gas supply is controlled by digital mass flow controllers and valves 520 under hw control of the computer system 400. This enables sensors to be efficiently and automatically tested in bulk. Optionally, tests take place periodically during stabilization and the sensor assemblies are then returned to stabilization racks 30 to continue stabilization. After fitting gas housings 24, a first test procedure 213 is carried out wit reference to pre-stored protocol 214, selected depending on the batch of sensors.

Computer system 400 then applies a test as piping network 510 and gas housing 24 to the sensors and makes electrical tests measuring the change in sensor reading on application of this test gas, thereby determining the sensitivity of the sensor assembly 10 to the analyte gas at that time. Protocols may define several gases to be supplied in set amounts for set periods of time.

Other tests include cross-sensitivity tests, establishing 1hi effect of an interferent gas on reading of analyte gas concentration. For the example of carbon monoxide sensor, it is envisaged that tests to check interference due to hydrogen are carried out and compared with an acceptable level. An example test for a carbon monoxide sensor supplies the sensor assembly with laboratory air for five minutes, then 400 ppm carbon monoxide for 10 minutes than laboratory air for a further 5 minutes, all at 0.3 litre/minute gas supply Working electrode current response to carbon monoxide is measured.

Preferably, stabilization is complete when the zero current monitored on stabilization rack 30 is stable and, optionally, when sensitivity to analyte gas measured on test rig 31 is stable. K not the response to lob air is monitored whilst the stabilization continues. When criterion is met, the next stage is a batch counter procedure 217 which monitors the number of hatches of sensor assemblies of a particular type which have passed through stabilization and individual testing and, when a designated number of kanbans have passed, establishes that a particular kanban of sensor assemblies should be presented for bath validation 218, otherwise, this batch test is skipped 219. Batch validation 218 is carried out in validation and research facility 300. In the preferred embodiment. whenever counting 217 determines that a batch of sensor assemblies should be submitted for batch validation 218, testing of further comparable sensor assemblies is halted until batch validation 218 is complete and testing is only rested if the batch passed the validation test.

FIG. 8 illustrates different regions of validation and research laboratory 300. As well as general lab space 330, enclosed volumes 310, 320 are preferably provided. For example, in the preferred embodiment there is provided both an environmental oven 310 and a fume hood 320. General laboratory space 330 can be used for carrying out custom tests set up by validation and research personnel. Importantly, each environment 310, 320 and 330 has a gas supply provided from the same central gas store 500 through pipe system 510 and gases supplied are controlled by computer system 400 by means of mass flow controllers 520. Outlets 450 supply gas to environmental oven 310 and fume hood 320 and gas connectors 460 allow custom connection of tubes to the gas supply by operators for specific experiments, Electrical connections 340 are provided through network 410 to the computer system 400 for controlling actuators and measuring parameters.

Examples of validation procedures include thermal cycling teas for investigating the performance of sensor assembles 10 in variable temperature environments. Other validation procedures include: long term drift experiments and checks for the effect of relative humidity and pressure sensitivity, Studies of the effect of a step change in gas flow rate or sensitivity to a cross-interfering, gas and also checks For lincarity and hysteresis are carried out in fume cupboard environment 320. Custom equipment may be assembled in lab space 330 for carrying out further validation studies, for example on the effects of sensor orientation, electrode performance, vibration and mechanical shock.

An example batch validation procedure for a carbon monoxide sensor measures the working electrode current response to carbon monoxide at ten equally spaced carbon monoxide concentrations across the measurement rates. The batch validation procedure looks not just at the plateau signal reached at each carbon monoxide concentration but checked working electrode output for unacceptable current spikes. Output current at each concentration is compared to a theoretical output calculated as a straight line extrapolation from zero (or another low calibration point) and a standard calibration point (400 ppm for carbon monoxide). Non-linearity at full scale (2000 ppm for carbon monoxide) is determined and if it is greater than a preset limit the kanban of sensor assemblies is rejected and all kanbans since the last batch validation are investigated. Procedures and gas concentrations can be readily varied by one skilled in the art for use with different sensor types3

A primary advantage of this customisablilty is that specific validation studies for particular customers or individual sensor types can be carried out readily whilst still retaining full automated traceability. Not only can results be recorded on computer system 400, but preferably the same gas supply is used for both manufacturing and testing. This improves reliability and reproducibility and makes it easier to retrospectively examine the causes of problems using trend analysis and makes it possible to provide newly detailed information to customers.

A further advantage is that research to device new assembly and test procedures can be carried out in validation and research facility 300. Corresponding assembly, test procedures, validation procedures and gas supplies can therefore be used as are subsequently employed for actual manufacture. Furthermore, information from these research procedures can be stored in the same database 460 and parameters such as laboratory conditions at the time the research took place can checked later.

Referring back to FIG. 6, kanbans of sensor assemblies are passed or failed 221. Failed batches are subject to a specified procedure for non conforming goods 222. Sensors used for batch validation are then stored as a historical record and are not allowed to reenter the supply chain If the sensors tested for batch validation perform within the specified limits then a set of tests 223 can then be applied to each individual sensor assembly of that kanban (excepting the batch validation sensors) with reference to test specification 214. This is achieved by again loading PCBs 20 onto test racks 30 and measuring sensor assembly response to analyte gas of known concentrations.

Thereafter, sensors are stored in bulk storage trays and a label is printed 224 for each storage tray. Subsequently this bulk storage tray label include a barcode which is scanned and customised labels are prepared for and fixed to each sensor assembly 225, providing a completed electrochemical gas sensor. Including this labelling step in the manufacturing process ensures that each sensor can be later cross referenced to information stored in the database 450 concerning that sensor in particular and general information (such as laboratory atmosphere conditions during tests), providing fill traceability. Each label can be customised for a particular customer showing particular information including logos, etc. Preferably each sensor label contains a bar code making it easy for customers to scan a particular sensor and so access the stored test and validation information. Labelling may take place at any stage during assembly, stabilization, test and validation. Preferably, however, sensor assemblies are stored in the bulk storage trays and only individually labelled, completing the manufacturing process, once it bas been ascertained which customer they will be sold to, enabling the labelling to correspond to that customers individual specification.

The final product sold preferably includes information from database 450 pertaining to a particular sensor or batch of sensors. This may be supplied in the form of computer disk, spreadsheet, printed listing, email file or other computer readable media Alternatively, relevant information may be printed on the sensor. Furthermore, an identifier or password could be supplied which a customer may use to access database 450 through external network connection and firewall 460.

Therefore, the present invention has provided sensors which have been accurately and customisably assembled, tested and validated and which can be made available with customised data pertaining to test and validation of that particular sensor. As a result, the customer can have greater faith in purchased sensors and in the event of any problem the customer or manufacturer can retrieve detailed information pertaining to the particular sensor or particular batch from which a sensor was manufactured. Also, failure analysis of either retuned sensors from customers or poor manufacturing yiields can be assessed using tools such as trend analysis from measurements taken in both the test and validation and research laboratories.

The centralised gas control system 500,510, 520 and centralised computer system 400 is important The overall manufacturing process allow human controlled stages, such as assembly, to be combined with carefully defined commonly carried out procedures, such as test specification 214, and rarely carried out, individually customised validation studies 215. Early identification of sensor type when sensor type is input 21 1 allows common test procedures to be carried out with little risk of operator error and computer system 400 is adapted to prompt operators to carry out additional procedures, such as batch validation protocols when requires

As a result, sensors can be economically manufactured in a highly customisable way without the complex, error-prone paperwork and variation in gas standards found in previous electrochemical gas sensor assembly facilities.

The system can also be used to test and validate third party sensors.

There is also provided a system validation method for use in checking the accuracy of components of the gas piping network 510 and flow controllers and valves 520. Gas storage facility 500 is illustrated in FIG. 9 and comprises a plurality of gas canisters 501 with regulators 502. A portion of gas piping network 510 comprises supply pipes 503 carrying individual gases from gas canisters 501. Manifold supply pipes 504 supply gas to testing manifolds 505 and the flow of gas from supply pipes 503 into manifold supply pipes 504 is controlled by digital mass flow controllers 521, being a subset of the digital mass flow controllers 520 provided throughout the manufacturing facility and under control of computer system 400.

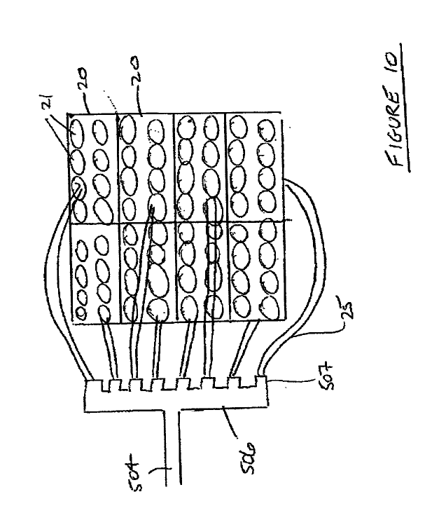

Manifolds 506 supply gas to sensors through nozzles 507. Preferably, nozzles are arranged in an array, for example, eight nozzles 507 per manifold 506, as illustrated in FIG. 10. This allows a kanban of sensor assemblies to be tested at once and is an efficient arrangement for distributing gas to sixty-four separate sensor assemblies during test or validation. Each sensor assembly 10 is mounted, as before, on a printed circuit board 20 and connections 22 and 27 are provided corresponding to FIG. 7 for supplying electrical signals to sensor electrodes and reading an analyte concentration dependent signal.

The validity of the tests would be compromised if different gas concentrations were supplied through different nozzles 507. Systematic errors could be introduced by variations in gas concentration in the cylinders 501, cylinder heads 502, supply pipes 503, digital mass flow controllers 521, manifold supply pipes 504 or in the gas distribution between different nozzles 507 in manifold 506. Errors include random errors and systematic bias errors caused by, for example, one digital mass flow controller 521 allow more gas through Man another or different nozzles 507 receiving different fractions of supplied gas. The most important errors are due to differences between digital mass flow controllers 521, which affect supply of gm to every nozzle 507 on a manifold 506 and differences between gas supply to individual nozzles 507.

The gas supply system is validated by measuring analyte concentration dependant signal for each sensor assembly in a kanban on several different manifolds 506 sequentially. By moving sensor assemblies to different locations, individual errors can be deconstructed. For example, the difference between the signal analyte concentration dependent signal from a single sensor assembly when tested at the same place on two different manifolds 506, equals the sum of the bias error difference due to errors in gas flow through individual digital mass flow controllers 521 used to supply selected gases and due to gas flow to the individual nozzle. Making analyte concentration dependent signal measurements using the same gas sensor in the same position on different manifolds allow differences in errors between manifolds to be calculated. Multiple repetitions with different sensors and the provision of multiple sensor assemblies 21 on each printed circuit board 20 allows random errors to be calculated.

Importantly, this procedure allows systematic errors to be calculated despite the fact Sat there is random variation between individual sensor assemblies 10 as all such errors cancel out in the deconstruction process.

Further modifications and changes may be made by one skilled in the art within the scope of the invention herein described.

1. A method of manufacturing an electrochemical gas sensor, comprising the steps of:
assembling components to form a sensor assembly having a plurality of electrodes and a plurality of terminals for making an external electrical connection to said electrodes, the sensor assembly providing a measurement dependant on an analyte gas concentration when an appropriate external circuit is applied to said terminals;
mounting said sensor assembly on an electrical circuit board having an individual electronically readable identifier, having connectors for connecting to said terminals of said sensor assembly and having a connection to a computer system;
applying an appropriate external electric circuit to said connectors to cause measurement properties of said sensor assembly to stabilise;
the electrical circuit board monitoring said stabilisation;
the computer system periodically reading and storing measurement properties of said sensor assembly during stabilisation, said stored measurement properties being attributable to said electrical circuit board identifier and therefore to a specific sensor assembly;
determining when said stabilisation process is complete;
determining whether to select the sensor assembly for batch validation and, if it is selected, carrying out at least one validation test on said sensor assembly, the validation test including the step of measuring a validation measurement property of said selected sensor assembly and storing said validation measurement property attributably to a specific sensor assembly.

2. The method of claim 1 wherein said validation measurement property is attributable to a specific sensor assembly due to said sensor assembly remaining connected to said electronic circuit board having an electrical circuit board identifier.

3. The method of Claim 1 further comprising the step of said electrical circuit board automatically testing a sensor assembly for a fault and, if a fault is found, communicating the existence of said fault.

4. The method of claim l further comprising the step of labelling said sensor assembly, said label providing identifier information enabling said stored properties to be attributed to said labelled sensor assembly.

5. A method of manufacturing an electrochemical gas sensor, comprising the steps of:
assembling components to form a sensor assembly having a plurality of electrodes and a plurality of terminals for making an external electrical connection to said electrodes, the sensor assembly providing an electrical signal dependant on an analyte gas concentration when an appropriate external circuit is applied to said terminals;
caring out at least one test on said sensor assembly, the results of said test being stored attributably to said sensor assembly; and
labelling said sensor assembly, said label providing identifier information enabling said test results relating to said sensor assembly to be retrieved.

6. The method of claim 5 further comprising the step of determining whether to select a sensor assembly for batch validation; wherein, if a sensor assembly is selected for batch validation, at least one validation test is carried out on said selected sensor assembly, said validation test results being stored attributably to a batch of sensors, wherein identifier information provided on a label enables validation test results relating to a batch of said sensor assemblies to be retrieved.

7. The method of claim 5 wherein said label is customised depending on the purchaser of said electrochemical gas sensor.

8. A method of manufacturing an electrochemical gas sensor, comprising the steps of:
assembling components to form a sensor assembly having a plurality of electrodes and a plurality of terminals for making an external electrical connection to said electrodes, the sensor assembly providing an electrical signal dependant on an analyte gas concentration when an appropriate external circuit is applied lo said terminals,
carrying out at least one test on said sensor assembly, said test including the steps of mea a first analyte gas concentration dependent electrical signal in a first controlled composition gas atmosphere;
storing said first measured signal and information concerning the first controlled composition gas atmosphere, said measured signal and information being attributable to said sensor assembly;
determining whether to select said sensor assembly for a validation study from a batch of said sensor assemblies and, if said sensor is assembly is selected, carrying out at least one validation test on the selected sensor assembly;
carrying out at least one validation study on said sensor assembly, said validation study including the step of making a second measurement of said analyte gas concentration dependent electrical signal in a second controlled composition gas atmosphere; and
storing said second measured signal and information concerning the second controlled composition gas atmosphere, said measured signal and information being attributable to said sensor assembly or said batch of said sensor assemblies.

9. The method of claim 8 wherein a single gas source supplies gas for both said test and said validation study.

10. The method of claim 8 wherein a single procedure defines gas supply during both said test and said validation study.

11. The method of claim 10 wherein said test procedure and said validation procedures were researched using said single procedure.

12. The method of claim 9 wherein said validation study further includes the step of connecting customised apparatus to outlets from said single gas source.

13. The method of claim 8 further comprising the step of halting said test procedure once a sensor assembly has been selected for validation until the results of said validation process are available.

14. The method of claim 13 wherein said test procedure is only restarted if the results of said validation process are favourable.

15. A system validation method for validating a gas supply system, the method comprising the steps of:
supplying gas to a plurality of manifolds, each manifold supplying gas to a plurality of nozzles, the supply of gas being controlled by mass flow controllers;
determining a property dependent on the concentration or amount of gas supplied to each nozzle by way of a plurality of electrochemical gas sensors, each located to give a signal dependent on the concentration or amount of gas supplied to an particular nozzle;
relocating a plurality of gas sensors to give a signal dependent on the concentration of amount of gas supplied to a different nozzle; and
thereby determining the difference in systematic errors in the gas supply to individual nozzles.

16. The method of claim 15 wherein a batch of gas sensors is located so that between them, they give signals dependent on the concentration or amount of gas supplied to each nozzle in a manifold, the relocation comprising moving said batch of sensors to another manifold and thereby determining the difference in systematic errors in the gas supply to individual manifolds.

17. The method of claim 15 wherein gas is supplied to manifolds through digital flow mass controllers and the method comprises the step of calculating the systematic error due to an individual mass flow controller.

18. The method of claim 15 wherein a plurality of gas sensors mounted on an electronic circuit board receive gas from the same nozzle and where signals from each gas sensor receiving gas from a particular nozzle are combined to improve accuracy.

19. A sensor package comprising an electrochemical gas sensor manufactured by the method of claim 1 and information pertaining to the results of said tests carried out on said sensor.

20. A sensor package comprising an electrochemical gas sensor manufactured by the method of claim 5 and information pertaining to the results of said tests carried out on said sensor.

21. A sensor package comprising an electrochemical gas sensor manufactured by the method of claim 8 and information pertaining to the results of said tests carried out on said sensor.
